(19) United States
(12) Patent Application Publication
(10) Pub. No.: US 2015/0144216 A1
(43) Pub. Date: May 28, 2015

(54) PISTON ACCUMULATOR

(71) Applicant: Carl Freudenberg KG, Weinheim (DE)

(72) Inventor: Thomas Pippes, Bad Ems (DE)

(21) Appl. No.: 14/549,585

(22) Filed: Nov. 21, 2014

(30) Foreign Application Priority Data
Nov. 25, 2013 (DE) 10 2013 019 613.2
Dec. 12, 2013 (DE) 10 2013 020 543.3

(51) Int. Cl. F15B 1/24

(52) U.S. Cl. CPC F15B 1/24; F15B 2201/40; F15B 2201/4053
USPC 138/31; 92/165 R

(57) ABSTRACT

A piston accumulator in which good sealing and guidance of a piston is ensured, even if the diameter of the housing undergoes expansion, the strength, weight and costs of the piston accumulator being optimised as far as possible, a piston accumulator, which has a housing defining a pressure chamber and receiving a movable piston, a compressible fluid being held in the pressure chamber, the piston having a housing side facing the pressure chamber and the piston having a working side which can face a working fluid that can move the piston with a bushing provided, within which the piston can move.

### CROSS-REFERENCE TO RELATED APPLICATIONS

Priority is claimed to German Patent Application No. DE 10 2013 019 613.2, filed on Nov. 25, 2013, and German Patent Application No. DE 10 2013 020 543.3, filed on Dec. 12, 2013, the entire disclosure of each of which is hereby incorporated by reference herein.

### FIELD

The invention relates to a piston accumulator having a housing, a pressure chamber, and a movable piston.

### BACKGROUND

Piston accumulators of this type are already known from the prior art. In the pressure chambers thereof, pistons are moved and are guided by the housing. The pistons are moved against the pressure of gases.

In the pressure chambers of these piston accumulators, gases are often held at a very high internal pressure. The housings of these piston accumulators therefore have to have relatively high rigidity so as to prevent the diameter thereof from expanding as a result of high internal pressures.

If the diameter does in fact expand, a piston seal can no longer function optimally. In addition, the guidance of the piston within the housing can no longer be ensured.

The rigidity of the housing is primarily determined by the wall thickness and the elastic modulus of the material from which the housing is produced.

When designing the piston accumulator currently being described, it is often necessary to either form the walls to be thicker than would be required to provide sufficient strength, or to use materials having a high elastic modulus. Both techniques lead to higher costs and increased weight.

### SUMMARY

An aspect of the invention provides a piston accumulator, comprising: a housing defining a pressure chamber and receiving a movable piston; and a bushing within which the movable piston can move, wherein a compressible fluid is held in the pressure chamber, wherein the movable piston includes a housing side facing the pressure chamber, wherein the piston includes a working side which can face a working fluid that can move the piston.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a sectional view of a first embodiment of a piston accumulator comprising a housing which defines a pressure chamber, a bushing being received inside the pressure chamber, which bushing has been relieved of pressure and guides the piston;

FIG. 2 is a sectional view of a second embodiment of a piston accumulator comprising a housing, in which the compressible, gaseous fluid within the pressure chamber does not touch the inner wall of the housing; and

FIG. 3 is a sectional view of a third embodiment of a piston accumulator comprising a housing which encloses two pressure chambers, one piston, which can move in the axial direction depending on the differential pressure, being arranged in each of the two pressure chambers.

### DETAILED DESCRIPTION

An aspect of the invention provides a piston accumulator in which good sealing and guidance of the piston thereof is ensured, even if the diameter of the housing thereof undergoes expansion, the strength, weight and costs of the piston accumulator all being optimised as far as possible.

In an aspect of the invention, the piston is not guided by the housing, but rather by a bushing. The pressurized fluids, namely liquids or gases, flow around and/or through part or all of this bushing. As a result, the bushing is hardly deformed at all by applied forces and is largely relieved of pressure. Expansion of the diameter of the bushing is therefore prevented. If the housing forms a casing for the pressure chamber at least in part, the housing can thus be less rigid than would actually be necessary for producing a sealing and guidance function for the piston. The variation in the diameter of the housing is tolerated. The housing can therefore be produced in a relatively inexpensive manner. The wall thickness thereof can also be relatively low, and the selection of the material is also not as limited. In this respect, a piston accumulator is provided in which good sealing and guidance of the piston is ensured, even if the diameter of the housing undergoes expansion, the strength, weight and costs of the piston accumulator all being optimized as far as possible.

The bushing can be received within the housing either in part or completely. This allows for a compact design of the piston accumulator. Preferably, the bushing does not project beyond the outer dimensions of the housing.

Advantageously, the housing can be attached to an arrangement such that a working fluid, such as a hydraulic fluid, can move the piston against the pressure of a gas in the pressure chamber.

The bushing can have an outer surface and an inner surface, both surfaces being in contact with or being acted upon by the pressure of the compressible fluid. This means that equal pressures can act on both surfaces, so that the bushing is either partly or completely relieved of pressure. The possibility of the bushing bending or being deformed is almost completely eliminated. The material of which the bushing consists merely has to be sufficiently rigid so as to be hardly compressed at all by the pressure of the compressible fluid. The compressible fluid is preferably a pressurized gas.

Alternatively, the bushing can have an outer surface and an inner surface, only the inner surface being in contact with or acted upon by the pressure of the compressible fluid and it being possible for the outer surface to be acted upon by the pressure of the working fluid. In such a configuration, it is advantageous for it to be possible to seal the bushing, on the end face thereof facing the housing side of the piston, by means of a bottom. In such a case, the bushing is formed substantially in the shape of a cup. The bushing can be formed to be completely impermeable to gas. The interior of the bushing is delimited by said bushing and by the piston, and is thus sealed with respect to the surroundings. For this purpose, the bushing can consist of a metal material. Such a configuration of the bushing means that the housing does not necessarily have to be designed to be impermeable to gas; the piston accumulator can thus be produced in a simple and inexpensive manner and thus also has consistently good performance characteristics over a long service life.

The smaller the surface inside the housing that is acted upon by the compressible fluid from the pressure chamber, the lower the risk of the compressible fluid diffusing into the surroundings through the housing and thereby impairing the performance characteristics of the piston accumulator.

In particular when the housing comprises or consists of a plastics material, the housing can be equipped, on the inside thereof, for gaseous media in a diffusion-tight manner, for example by means of coating that is impermeable to gas.

The proportion of the inner surface that is in contact with the compressible fluid can depend on the movement position of the piston. As a result, a working fluid can enter the housing and push the piston into the housing. A liquid is preferably used as a working fluid. It is, however, also conceivable to use a gas as the working fluid.

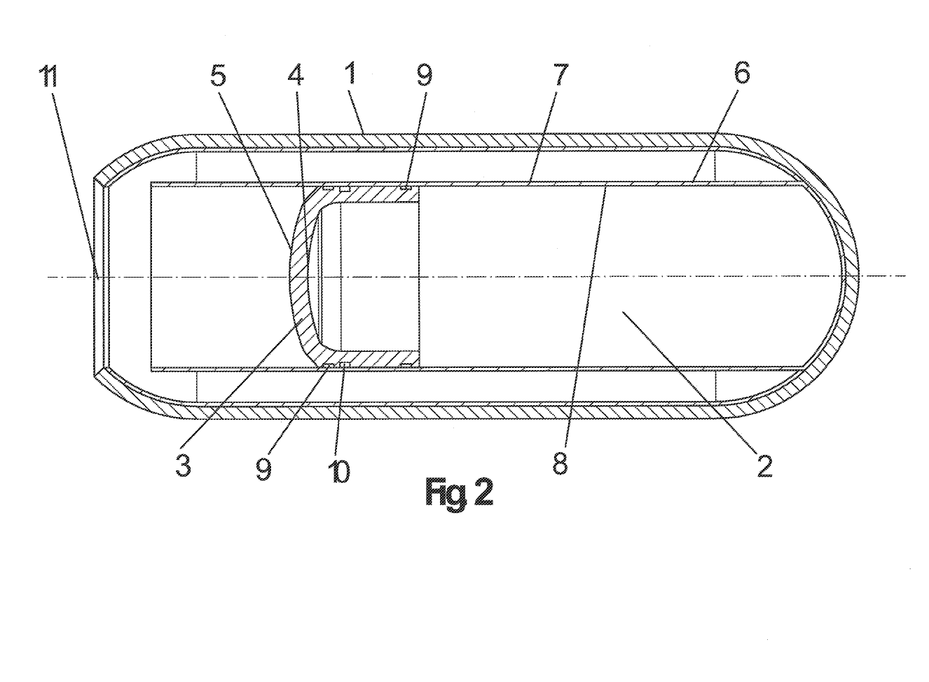

The proportion of the inner surface that is in contact with the working fluid can depend on the movement position of the piston. Owing to this specific configuration, the working fluid can relieve the pressure on the bushing, in that said working fluid specifically pushes against the bushing from inside and counteracts either the pressure of the compressible fluid or the working fluid itself, as shown in FIG. 2. In this case, the pressure of the compressible fluid in the pressure chamber approximately corresponds to the pressure of the working fluid. The compressible fluid is preferably a gas.

The bushing and the housing can be arranged concentrically. This allows the piston accumulator to be produced in a simple manner.

The bushing and the housing can be arranged so as not to be concentric. This configuration can be advantageous in certain installation spaces.

The bushing can comprise or consist of a plastics material. As a result, it is possible to produce a very light piston accumulator. The plastics material is preferably fiber reinforced, in particular carbon fiber reinforced and/or glass fiber reinforced.

The bushing can comprise or consist of a metal. The bushing can thus also withstand relatively aggressive materials such as machine oils. The metal is preferably a steel.

The housing can comprise or consist of a plastics material. As a result, it is possible to produce a very light piston accumulator. The plastics material is preferably fiber reinforced, in particular carbon fiber reinforced and/or glass fiber reinforced.

The housing can comprise or consist of a metal. The housing can thus withstand relatively aggressive materials such as machine oils. The metal is preferably aluminum.

The bushing and/or the housing can preferably be formed to be gas-diffusion-tight. If the bushing and/or the housing do not consist of a metal material, they can be specifically equipped for this purpose, for example by means of a coating.

A plurality of bushings can be provided, within which pistons can be moved or guided. One piston can move in each bushing. As a result, an individual piston can be selectively actuated or used, while one single pressure chamber is provided for a plurality of pistons.

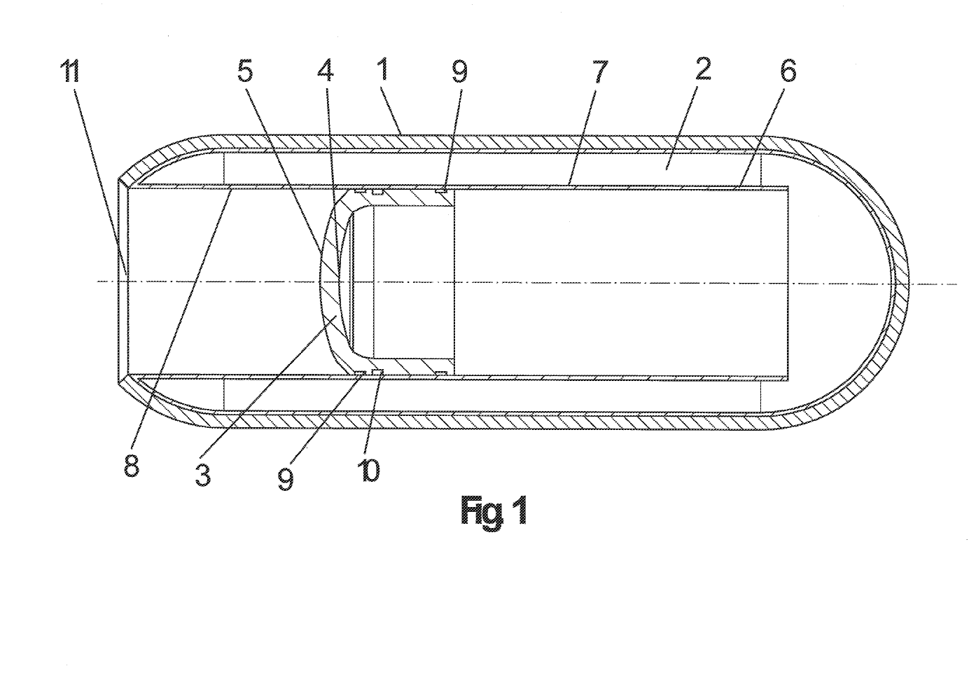

FIG. 1 is a sectional view of a piston accumulator comprising a housing 1 which defines a pressure chamber 2 and receives a movable piston 3, a compressible fluid being held in the pressure chamber 2, the piston 3 having a housing side 4 which faces the pressure chamber 2 and the piston 3 having a working side 5 which can face a working fluid that can move the piston 3. A bushing is provided 6, within which the piston 3 can move. The bushing 6 guides the piston 3.

The compressible fluid is a gas. The housing 1 has a connection opening 11 so that working fluid can enter the housing 1 and move the piston 3. The pressure chamber 2 is defined by the bushing 6, the piston 3 and the housing 1, and encloses a variable volume.

The bushing 6 is received completely within the housing 1. The bushing 6 is formed as a cylindrical tube.

The bushing 6 has an outer surface 7 and an inner surface 8, both surfaces 7, 8 being in contact with or being acted upon by the pressure of the compressible fluid.

The proportion of the inner surface 8 that is in contact with the compressible fluid depends on the movement position of the piston 3. The proportion of the inner surface 8 that is in contact with the working fluid likewise depends on the movement position of the piston 3. The further the piston 3 is driven back into the housing 1 by the working fluid, the greater the proportion of the inner surface 8 that is in contact with the working fluid. The piston 3 slides on the inner surface 8 and is guided by the bushing 6.

The bushing 6 and the housing 1 are arranged concentrically. The bushing 6 consists of a metal, namely of steel. The housing 1 consists of a fiber reinforced plastics material. The plastics material can, for example, be carbon fiber reinforced or glass fiber reinforced. In addition, a device that is impermeable to gas, for example a gas seal, a liner or a coating, is applied to the inside of the housing.

Two guide rings 9 are arranged on the piston 3, a sealing ring 10 being located axially therebetween. The piston 3 is convex on the working side 5 thereof and concave on the housing side 4 thereof. The piston 3 is formed to have a U-shaped cross section.

The housing 1 and the bushing 6 are arranged concentrically with one another. The outer surface 7 of the bushing 6 is completely surrounded by gas. The inner surface 8 is acted upon by gas or by liquid depending on the position of the piston 3. The inner surface 8 is acted upon more by gas or more by liquid depending on the position of the piston 3.

FIG. 2 is a sectional view of a second embodiment of a piston accumulator comprising a housing 1, in which the compressible, gaseous fluid located in the pressure chamber 2 is not in direct contact with the inner wall of the housing 1.

The bushing 6 is formed in a cup shape and is sealed, on the end face facing the housing side 4 of the piston 3, by a bottom which forms a part of the housing 1 and is formed to be impermeable to gas on the side facing the pressure chamber 2. This can be achieved by a device that is impermeable to gas, for example a gas seal, a liner or a coating. In the embodiment shown, the bushing 6 consists of a metal material and is thus completely impermeable to gas. Configuring the bushing 6 in this way means that the housing 1 does not also have to be formed to be impermeable to gas. Since it is practically impossible for the compressible fluid to escape from the pressure chamber 2, the piston accumulator has consistently good performance characteristics over a long service life. The bushing 6 has an outer surface 7 and an inner surface 8, only the inner surface 8 being in contact with and being acted upon by the pressure of the compressible and gaseous fluid from the pressure chamber 2. The outer surface 7 can be acted upon by the pressure of the working fluid, which in this case is formed by an oil. In the embodiment shown, no part of the inside of the housing 1 is in contact with compressible and gaseous fluid from the pressure chamber 2.

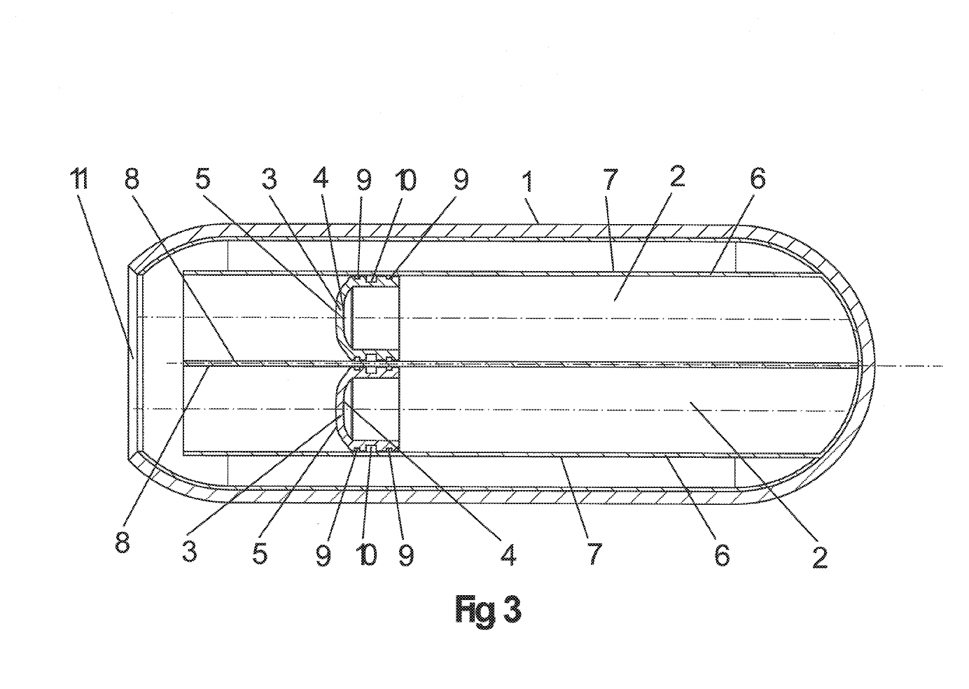

FIG. 3 is a sectional view of a third embodiment of a piston accumulator comprising a housing 1 which encloses two pressure chambers 2, one piston 3, which can move in the axial direction depending on the differential pressure, being arranged in each of the two pressure chambers 2.

As a result, each individual piston 3 can, as required, be selectively actuated and used.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

1. A piston accumulator, comprising:
a housing defining a pressure chamber and receiving a movable piston; and
a bushing within which the movable piston can move,
wherein a compressible fluid is held in the pressure chamber,
wherein the movable piston includes a housing side facing the pressure chamber,
wherein the piston includes a working side which can face a working fluid that can move the piston.

2. The accumulator of claim 1, wherein the bushing is at least partially received within the housing.

3. The accumulator of claim 1, wherein the bushing includes an outer surface and an inner surface,
wherein both the outer and inner surfaces are in contact with the compressible fluid.

4. The accumulator of claim 1, wherein the bushing includes an outer surface and an inner surface,
wherein only the inner surface is in contact with the compressible fluid, and
wherein the outer surface can be acted upon by the pressure of the working fluid.

5. The accumulator of claim 3, wherein a proportion of the inner surface that is in contact with the compressible fluid depends on a movement position of the movable piston.

6. The accumulator of claim 3, wherein a proportion of the inner surface that is in contact with the working fluid depends on a movement position of the piston.

7. The accumulator of claim 1, wherein the bushing and the housing are arranged concentrically.

8. The accumulator of claim 1, wherein the bushing and the housing are not arranged concentrically.

9. The accumulator of claim 1, wherein the bushing includes a plastic.

10. The accumulator of claim 1, wherein the bushing includes a metal.

11. The accumulator of claim 1, wherein the housing includes a plastic.

12. The accumulator of claim 1, wherein the housing comprises a metal.

13. The accumulator of claim 1, comprising a plurality of bushings, within which pistons can move.

14. The accumulator of claim 1, wherein the bushing is completely received within the housing.

15. The accumulator of claim 1, wherein the bushing includes an outer surface and an inner surface,
wherein both the outer and inner surfaces are acted upon by pressure of the compressible fluid.

16. The accumulator of claim 1, wherein the bushing includes an outer surface and an inner surface,
wherein only the inner surface is acted upon by the pressure of the compressible fluid, and
wherein the outer surface can be acted upon by the pressure of the working fluid.

17. The accumulator of claim 1, wherein the bushing consists of at least one plastic.

18. The accumulator of claim 1, wherein the bushing consists of at least one metal.

19. The accumulator of claim 1, wherein the housing consists of at least one plastic.

20. The accumulator of claim 1, wherein the housing consists of at least one metal.
